(19) United States
(12) Patent Application Publication
(10) Pub. No.: US 2001/0013056 A1
(43) Pub. Date: Aug. 9, 2001

(54) Information processor having electronic mail function and recording medium storing electronic mail processing program

(76) Inventors: Yasuhisa Mori, Hitachi-shi (JP); Akihiro Kaneko, Tokai-mura (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/772,082

(22) Filed: Jan. 30, 2001

(30) Foreign Application Priority Data
Feb. 3, 2000 (JP) 2000-26859

(51) Int. Cl. G06F 15/16

(52) U.S. Cl. 709/206; 709/236; 709/246

(57) ABSTRACT

Sending and receiving of electronic mail attached with a large-sized file can be made easy. When a size of mail to be sent exceeds an upper limit value of mail size, the mail is sent by automatically dividing the sent mail into a plurality of sub-mail sections, and the plurality of received items of divided mail are automatically reconstituted to a single original form of the mail data.

### BACKGROUND OF THE INVENTION

The present invention relates to an information processor having an electronic mail function and a recording medium storing an electronic mail processing program.

Sending and receiving of a file or the like between a plurality of information processors is performed in a form of attaching a file to a text of electronic mail using an electronic mail system connected to a public communication line or a network.

However, there are problems that since a size of electronic mail is increased by attaching a large sized file such as image data to the text of mail, the remaining capacity of a mail server is largely decreased, which causes incapability of receiving the following electronic mail, and that since a large volume of data is carried on a communication line, the performance of the communication line, particularly the analogue communication line, is degraded.

In order to solve these problems, some mail servers executes measures that a limit (an upper limit) is set in the size of sent or received electronic mail, and electronic mail having a size exceeding this limit is not handled, or that electronic mail having a size exceeding a preset size is not immediately sent, but is sent a time zone when the communication line is not busy.

However, in the case of the mail server giving the limitation to mail size, since a large-sized file can not attached to electronic mail, it is necessary to send and receive the file using another means. Therefore, there is a limitation in effective use of the electronic mail.

On the other hand, in the case of the mail server sending and receiving electronic mail by controlling the time zone, since it is impossible to send and receive electronic mail without delay, a file can not be sent or receive in appropriate time. Therefore, working efficiency using the file is degraded.

A user can send electronic mail by dividing a file to be sent into small-sized files and attaching each of the divided files to a piece of the electronic mail. However, since the work to divide the file to be sent and the work to send the file by attaching each of the divided files to each of the plural pieces of the same electronic mail are necessary, the sending work by the user becomes complicated. Further, since the receiver is required to reconstitute the plural divided files attached to the plural pieces of the same electronic mail to the single original file, the receiving work becomes complicated.

### SUMMARY OF THE INVENTION

An object of the present invention is to provide an information processor having an electronic mail function which can easily attach a large-sized file to a piece of electronic mail, and send or receive it, and to provide a recording medium storing an electronic mail processing program for the information processor.

The present invention is characterized by an information processor having an electronic mail function, which comprises a mail size upper limit value storing means for storing at least one upper limit value of a sending destination mail size; a mail size comparing means for comparing the upper limit value stored in the mail size upper limit value storing means with a size of a mail main part of sent mail; a sent mail dividing means for dividing the sent mail into a plurality of sub-mail sections when the size of the sent mail exceeds the mail size upper limit value; and a mail sending means for sequentially sending sets of information individually including the divided sub-mail sections.

Further, the present invention is characterized by the information processor having an electronic mail function, which further comprises a destination-based information registration database, data being registered in the destination-based information registration database, the data being destination-based information including whether or not a mail address, a mail upper limit value and a divided mail reconstituting program for reconstituting the plurality of divided sub-mail sections to the original mail exist in each destination.

Further, the present invention is characterized by the information processor having an electronic mail function, which further comprises means for setting data to the destination-based information registration database, the data being information on judging whether or not there is necessity of attaching the reconstituting program.

Further, the present invention is characterized by the information processor having an electronic mail function, which further comprises a mail dividing information adding means for adding mail dividing information necessary for reconstituting the plurality of divided sub-mail sections to the original mail form to each of the sets of information.

Further, the present invention is characterized by the information processor having an electronic mail function, wherein the mail dividing information attached to each of the sub-mail sections includes an identification code for identifying the original mail, sub-numbers for expressing order of the sub-mail sections, a dividing number of the mail, and a capacity of each of the sub-mail sections.

Further, the present invention is characterized by the information processor having an electronic mail function, wherein the reconstituting program is a program for reconstituting the original mail based on all the received sub-mail sections and the mail dividing information attached to each of the sub-mail sections.

Further, the present invention is characterized by the information processor having an electronic mail function, which further comprises a means for automatically attaching the dividing mail reconstituting program to sent mail when it is judged that a destination does not have the divided mail reconstituting program.

Further, the present invention is characterized by the information processor having an electronic mail function, wherein the mail size upper limit value storing means comprises a mail size upper limit value storing part; and a mail size upper limit value input means for inputting a mail size upper limit value for each destination, the mail size upper limit value being stored in the mail size upper limit value storing part.

Further, the present invention is characterized by the information processor having an electronic mail function, wherein the mail size upper limit value storing means further comprises a mail size upper limit value switching means for switching a mail size upper limit value used by the mail size comparing means corresponding to a destination.

Further, the present invention is characterized by the information processor having an electronic mail function, which further comprises means for setting a subject name for each of the divided sub-mail sections, the subject name being a name of an original mail added with data corresponding to number of divided sections and dividing order of the sub-mail sections.

Further, the present invention is characterized by the information processor having an electronic mail function, wherein it is displayed on a display unit of the information processor that sent mail is divisionally being sent.

Further, the present invention is characterized by the information processor having an electronic mail function, wherein the dividing number is set so as to be minimized.

Further, the present invention is characterized by the information processor having an electronic mail function, wherein the dividing number is set so as to equalize capacities of the divided sub-mail sections.

Furthermore, the present invention is characterized by an information processor having an electronic mail function, which comprises a mail dividing judging means for judging whether or not mail dividing information is added in received mail data; a divided-mail receiving judging means for judging referring to the mail dividing information whether or not all of divided sending sub-mail sections can be received; and a mail reconstituting means for reconstituting the received sections of divided sending sub-mail data to a form of a single original item of sending mail data.

Further, the present invention is characterized by the information processor having an electronic mail function, wherein it is displayed on a display unit of the information processor that received mail is divisionally being sent.

Furthermore, the present invention is characterized by a method of sending and receiving electronic mail, the method comprising the steps of accepting a request of sending mail; acquiring a mail size upper limit value of a destination based on an address of the destination; comparing a size of the mail to be sent with the mail size upper limit value of the destination; dividing the mail to be sent into sub-mail sections according to an appropriate dividing method and sending the sub-mail sections by attaching dividing information to each of the sub-mail sections, when the size of the mail to be sent is larger than the mail size upper limit value of the destination; attaching a reconstituting program of divided mail to the sent mail when the reconstituting program is not provided to the destination; and directly sending the mail to be sent when the size of the mail to be sent is smaller than the mail size upper limit value of the destination.

Further, the present invention is characterized by the method of sending and receiving electronic mail, wherein when the mail to be sent is divisionally sent, it is displayed on a display unit that the mail is divisionally sent.

Furthermore, the present invention is characterized by a method of sending and receiving electronic mail, the method comprising the steps of judging whether or not received mail is divisionally being sent; after receiving all divided sub-mail sections, reconstituting the received sub-mail sections to a mail before divided using a reconstituting program and dividing information attached to each of the divided mail sections when the received mail is divisionally sent; and executing normal receiving processing when the received mail is not divisionally sent.

Further, the present invention is characterized by the method of sending and receiving electronic mail, wherein when the received mail is divisionally sent, it is displayed on a display unit that the mail is divisionally sent.

Furthermore, the present invention is characterized by a recording medium storing an electronic mail processing program for realizing an electronic mail function by loading the electronic mail processing program into an information processor, wherein the electronic mail processing program includes a program executing processing for comparing an upper limit value of sent mail size with a size of mail to be sent; and processing for sending the mail by automatically dividing mail data to be sent into a plurality of sub-mail sections when the size of the mail to be sent exceeds the upper limit value of sent mail size.

Further, the present invention is characterized by the recording medium storing an electronic mail processing program, which further includes a program for executing mail dividing information adding processing for adding information into sent mail data, the information being necessary for reconstituting divided items of divisional sub-mail data to a single original item of mail data.

Further, the present invention is characterized by the recording medium storing an electronic mail processing program, which further includes a program executing processing for attaching a reconstituting program for reconstituting divided items of divisional sub-mail data to a single original item of mail data; and processing for setting to a destination database whether or not attaching of the reconstituting program is necessary.

Further, the present invention is characterized by the recording medium storing an electronic mail processing program, which further includes a program executing mail size upper limit value setting processing for setting an upper limit value of sent mail size; and mail size upper limit value storing processing for storing the upper limit value of sent mail size set in the mail size upper limit value setting processing in a destination database an information processor.

Further, the present invention is characterized by the recording medium storing an electronic mail processing program, which further includes a program executing processing for switching the upper limit value of mail size referring to the destination database corresponding to a destination.

Further, the present invention is characterized by the recording medium storing an electronic mail processing program, which further includes a program executing processing for automatically changing a subject name of each of items of divided mail data to each subject name corresponding to number of divided sections and dividing order of each of the items of divided mail data.

Furthermore, the present invention is characterized by a recording medium storing an electronic mail processing program for realizing an electronic mail function by loading the electronic mail processing program into an information processor, wherein the electronic mail processing program includes a program executing mail dividing information judging processing for judging whether or not mail dividing information is attached to received mail data; divided mail receiving judging processing for judging based on the mail dividing information whether or not all necessary items of divided sent sub-mail data have been received; and mail reconstituting processing for reconstituting the received plurality of items of divided sent sub-mail data to a single original item of sending mail data.

### BRIEF DESCRIPTION OF DRAWINGS

FIG. 1 is a block diagram showing an embodiment of an information processor having an electronic mail function in accordance with the present invention.

FIG. 2 is a block diagram showing a functional means realized by executing an electronic mail processing program for sending electronic mail using a CPU in the information processor having the electric mail function in accordance with the present invention.

FIG. 3 is a view showing the structure of a database stored in an auxiliary memory unit in the information processor having the electronic mail function in accordance with the present invention.

FIG. 4 is a view showing the structure of electronic mail data.

FIG. 5 is a schematic view showing an electronic mail data dividing method executed by a sending mail dividing means in the information processor having the electronic mail function in accordance with the present invention.

FIG. 6 is a view showing the structure of a mail dividing information file in the information processor having the electronic mail function in accordance with the present invention.

FIG. 7 is a flowchart showing electronic mail sending processing executed by a preferable electronic mail processing program in order to realize the information processor having the electronic mail function in accordance with the present invention.

FIG. 8 is a block diagram showing a functional means realized by executing an electronic mail processing program for performing receiving processing of electronic mail in the information processor having the electric mail function in accordance with the present invention.

FIG. 9 is a flowchart showing electronic mail receiving processing executed by a preferable electronic mail processing program in order to realize the information processor having the electronic mail function in accordance with the present invention.

FIG. 10 is a view showing the inner structure of a divided mail storing unit in the information processor having the electronic mail function in accordance with the present invention.

### DESCRIPTION OF THE PREFERRED EMBODIMENTS

An embodiment of the present invention will be described below, referring to the accompanied drawings.

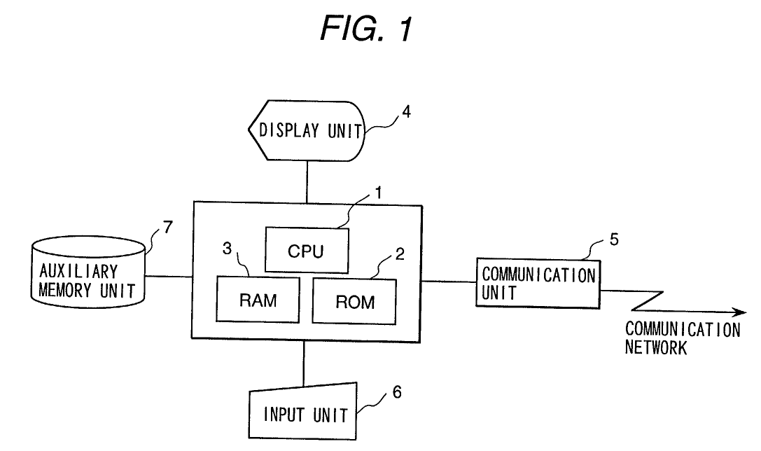

FIG. 1 is a block diagram showing an embodiment of an information processor having an electronic mail function in accordance with the present invention. Referring to FIG. 1, the reference character 1 is a CPU (central processing unit) for realizing various kinds of functional means to be described later by executing a program and for controlling various kinds of units. The reference character 2 is a ROM (read-only memory) for storing the above-mentioned program. The reference character 3 is a RAM (random access memory) for storing data used when an application program and the above-mentioned program are executed. The reference character 4 is a display unit for displaying a result of executing the programs or a mail letter. The reference character 5 is a communication unit for sending and receiving mail data through a communication network. The reference character 6 is an input/output unit for inputting a mail letter and for inputting information to control the various kinds of units. The reference character 7 is an auxiliary memory unit such as a hard disk unit for storing and memorizing the programs, electronic mail data to be sent or received and the other necessary information in the information processor. An electronic mail processing program is pre-stored into the ROM, or is read from a recording medium such as a compact disk or a floppy disk and then stored in the auxiliary memory unit 7.

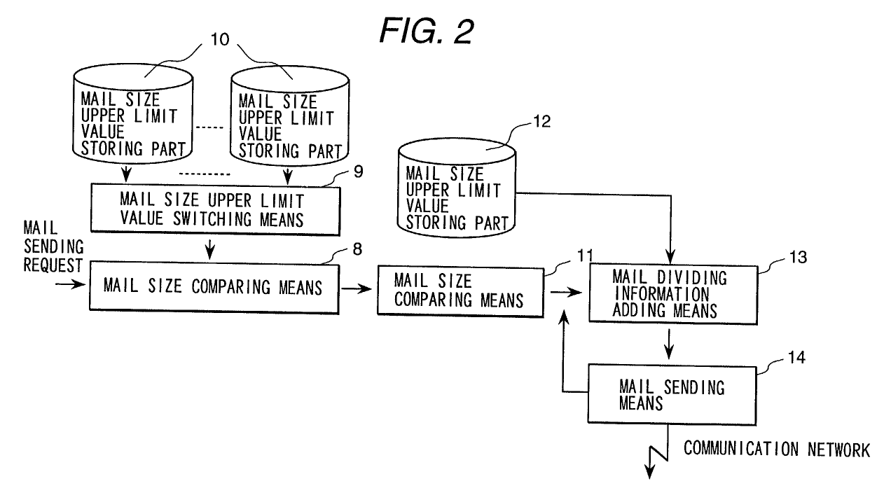

FIG. 2 is a block diagram showing a functional means realized by executing an electronic mail processing program for sending electronic mail using the CPU 1 in the information processor having the electric mail function in accordance with the present invention, and shows the functional means from inputting of a mail sending request through the input unit 6 to sending of the mail. When a size of electronic mail to be sent is smaller than a mail size upper limit value, the electronic mail is sent similarly to a conventional processor without any particular processing. Therefore, the illustration relating this case is omitted.

As a request of sending mail is input from the input unit 6, a mail size comparing means 8 acquires a mail size upper limit value corresponding to a destination from a mail size upper limit value storing part 10 using a mail size upper limit value switching means 9, and compares a size of the sending mail with the mail size upper limit value. The mail size upper limit value is pre-stored in the mail size upper limit value storing part 10 by a mail size upper limit value input means for storing mail size upper limit value inputs in the mail size upper limit value storing part of the destination database in the information processor.

When the sent mail size exceeds the mail size upper limit value, the sent mail data is divided into a plurality of divided sent mail items (sub-mail sections) each having a size smaller than the mail size upper limit value by a sending mail dividing means 11. At that time, processing of storing mail dividing information, which is necessary for reconstituting the plurality of divided sent mail data items to a form of a single original item of sent mail data, is also performed.

Next, a mail dividing information adding means 13 performs processing of adding mail dividing information stored in the mail dividing information storing means 12 to each of the divided sent mail sections which are divided by the sent mail dividing means 11.

Then, a mail sending means 14 sends each of the divided sent mail data items to which the mail dividing information is added.

Here, each of the means shown in FIG. 2 will be described in detail.

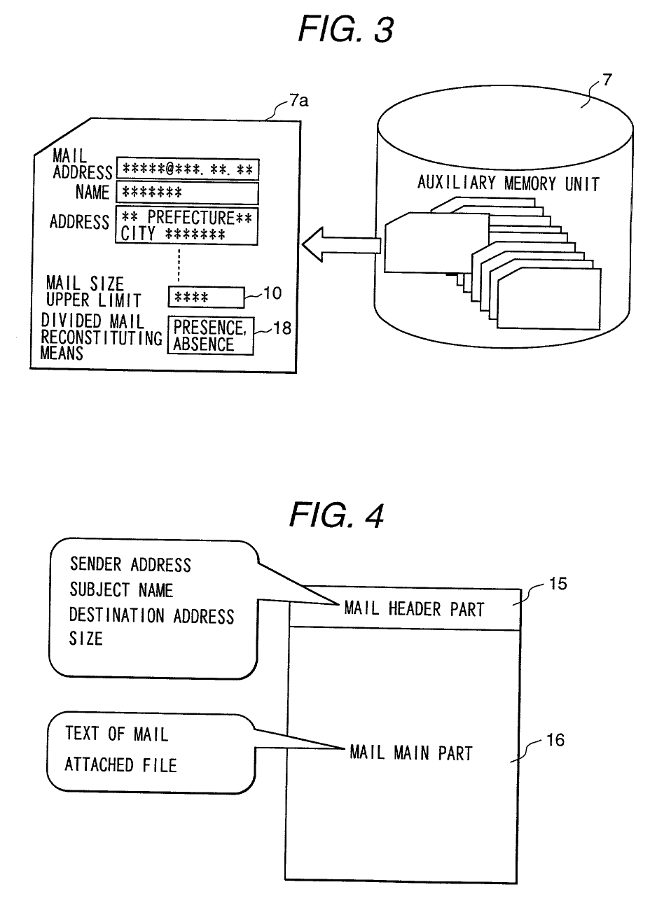

As shown in FIG. 3, personal information data such as each mail address, name, address and so on is gathered in a card-form to be stored in the auxiliary memory unit 7 as a database, and the mail size upper limit value storing part 10 is formed as a part of each personal information data card 7a to store the mail size upper limit value. This database can be also used as an address book which is referred when a destination of electric mail is specified. Therefore, the mail size upper limit value switching means 9 is constructed so as to initially search the database using a destination address as a keyword, and to acquire a mail size upper limit value from the mail size upper limit value storing part 10 of the corresponding data card (destination-based information data) 7a.

The sent mail dividing means 11 and the mail dividing information adding means 13 will be described below.

In this embodiment, the electric mail data is roughly classified into two parts, that is, a mail header part 15 and a mail main part 16, as shown in FIG. 4. The mail header part 15 includes data such as sender address, subject name, destination address, size and so on, and the mail main part 16 contains a text of mail and an attached file. Therein, the attached file also contains data-compression processed file data.

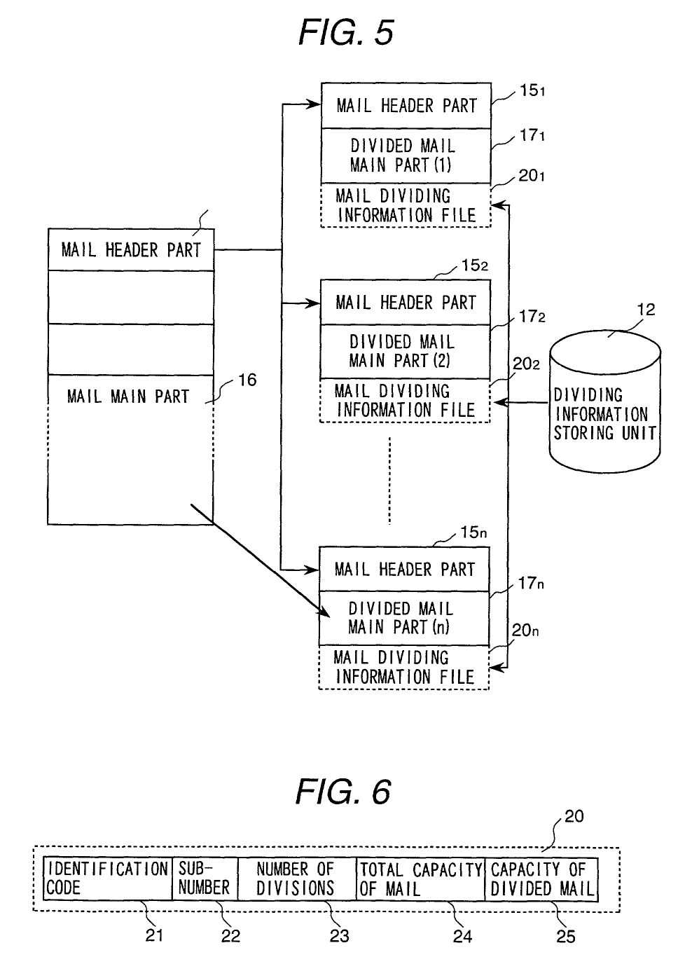

The sent mail dividing means 11 changes such electronic mail data to be sent into the form that only the mail main part 16 is divided into a plurality of divided mail main parts (1) 171 to (n) 17n, and the mail header part 15 (151 to 15n) is attached to each of the divided main parts (1) 171 to (n) 17n, as shown in FIG. 5. Therein, a user can select a dividing method among minimizing number of the sub-mail sections, equalizing the size of the sub-mail sections or the other, which determines number of the divided sub-mail sections of the mail. At that time, in each of the mail header parts 151 to 15n, the size information based on the original mail header part 15 is replaced by a mail size value corresponding to each of the divided mail main parts (1) 171 to (n) 17n which are added to the mail header parts 151 to 15n, respectively. Further, the sent mail dividing means 11 mail dividing information, which is used for reconstituting the plurality of divided sent male data items divided as described above to the single original form of the sent mail data, is stored in the mail dividing information storing means 12.

Next, the mail dividing information adding means 13 converts the mail dividing information stored in the mail dividing information storing means 12 into file format to form mail dividing information files 201 to 20n, and adds each of them to each of the divided sent mail data items as an attached file of the sent mail. A certain extension capable of identifying the original file is added to the mail dividing information files 201 to 20n in order to recognize as the mail dividing information at receiving the mail.

Each of the mail dividing information files 20 (201 to 20n) is constructed so as to contain an identification code 21, a sub-number 22, number of divisions 23, a total capacity of mail 24, and a capacity of divided mail 25. The identification code 21 is a code specific to the original sent mail data before being divided. By attaching the same identification code to all of the plurality of divided sent mail data items which are divided from the single sent mail data item, the divided sent mail data items are prevented from mixed with the other mail data when the received divided mail data items are reconstituted to the single original form before being divided of mail data in the receiver side. The sub-number 22 expresses order of the divided sent mail data items when the divided received mail data items are reconstituted to the single form of the received mail data. The sub-number 22 is stored when the mail dividing information adding means 13 attaches the mail dividing information files 201 to 20n to the sub-mail sections. Further, when the mail is divided using the above-mentioned means and is actually sent and received, a confirmation message is displayed on the display unit 4. The confirmation massage expresses that the mail is divisionally being sent, or that the received mail is divisionally being sent.

The above-described construction is processing in the case where the information processor having the electronic mail function in the receiver side comprises the means for automatically reconstituting the plurality of divided received mail data items to the single original form of the received mail data.

Description will be made below on processing in the case where the information processor having the electronic mail function in the receiver side does not comprise the means for automatically reconstituting the plurality of divided received mail data items to the single original form of the received mail data.

Presence or absence of the divided mail reconstituting means in the information processor having the electronic mail function in the receiver side is judged by providing a divided mail reconstituting means presence/absence information aria 18 in the database described referring to FIG. 3 and by inputting and pre-storing the information into the area 18. The divided mail reconstituting means presence/absence information is input from the input unit 6.

When electronic mail is sent, the mail dividing information adding means 13 judges referring to the divided mail reconstituting means presence/absence information on an information processor having the electronic mail function in a destination whether or not the information processor in the destination has the divided mail reconstituting means. If the information processor in the destination does not have the divided mail reconstituting means, the mail dividing information adding means 13 adds a divided mail reconstituting program for executing divided mail reconstituting processing as an attached file to each of the divided sent mail sections together with each of the mail dividing information files 201 to 20n, respectively. Further, the subject name of the divided sent mail is made a change corresponding to the information stored in each of the mail dividing information files 201 to 20n. For example, in a case where the subject name of the sent mail before being divided is “Re: holding a meeting”, the subject name of the divided sent mail is changed to “Re: holding a meeting (M/N)” (where M is sub-number 22, and N is number of mail divisions). In addition, at the same time, a sentence notifying the receiver that the mail is divided and sent is attached to the mail main part. By this function, when the information processor not having the means for automatically reconstituting divided mail receives divided sent mail, it is possible to avoid confusion caused by successively receiving a plurality of electronic mail pieces having the same subject name from a single information processor.

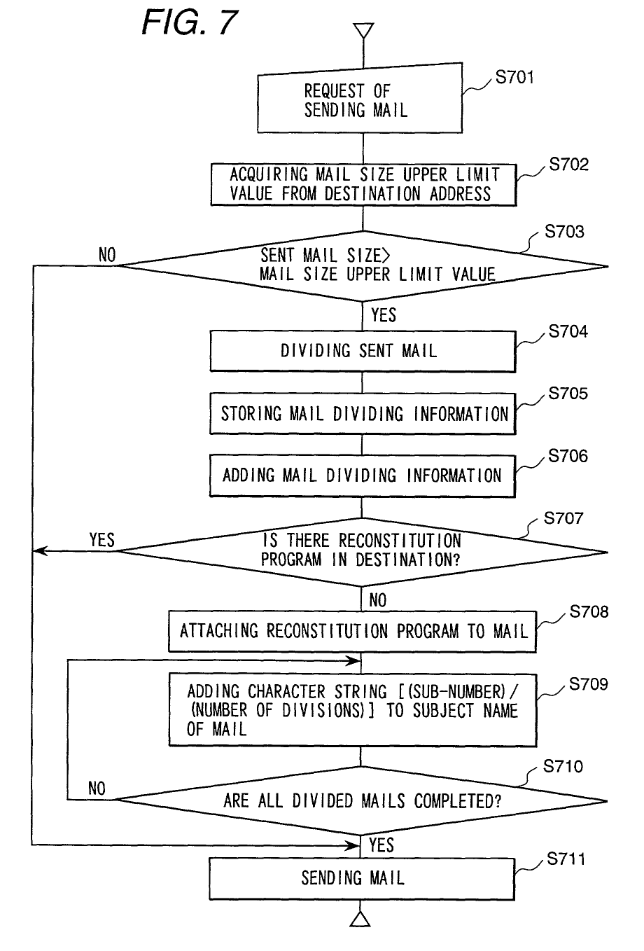

FIG. 7 is a flowchart showing electronic mail sending processing executed by a preferable electronic mail processing program in order to realize the information processor having the electronic mail function as described above.

Processing Step S701:

A mail sending request is input from the input unit 6.

Processing Step S702:

The database is searched using a destination address as a keyword to acquire a mail size upper limit value from the mail size upper limit value storing part 10 of the corresponding data card (destination-based information data) 7a.

Processing Step S703:

The sent mail size is compared with the mail size upper limit value, and the processing is branched to the processing step S704 or the processing step S711 depending on the comparison result, large and small.

Processing Step S704:

The sent mail data is divided into a plurality of divided sent mail sections having a size smaller than the mail size upper limit value.

Processing Step S705:

The mail dividing information necessary for receiving the plurality of divided sent mail data items obtained by dividing the sent mail data and for reconstituting them to the single original form of the received mail data is store in the mail dividing information storing means 12.

Processing Step S706:

The mail dividing information file is attached to each of the divided sent mail sections.

Processing Step S707:

It is judged referring to personal information data for a destination whether or not the information processor in the destination of the electronic mail has a program for receiving the plurality of divided sent mail data items obtained by dividing the sent mail data and for reconstituting them to the single original form of the received mail data.

Processing Step S708:

The reconstituting program is attached to the divided sent mail as an attached file.

Processing Step S709:

Subject name of the divided sent mail sections are changed. The change of subject name is performed, for example, by adding “sub-number/number of divisions” to the subject name of the sent mail before being divided.

Processing Step S710:

It is checked whether or not the change of subject name for all the divided sent mail sections is completed. If not, the processing returned to the processing step S709.

Processing Step S711:

Each of the divided sent mail data items is sent.

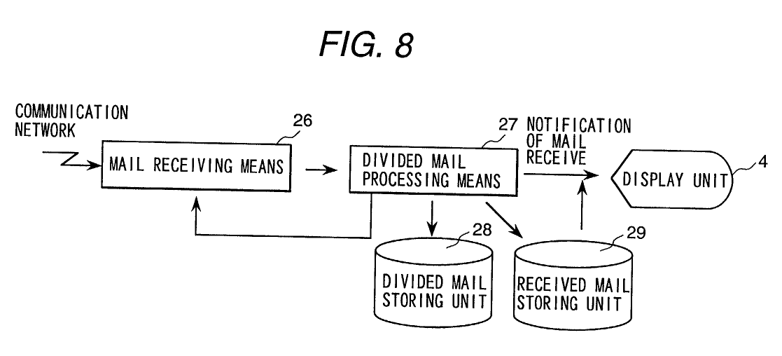

FIG. 8 is a block diagram showing a functional means realized by executing an electronic mail processing program for performing receiving processing of electronic mail in the information processor having the electric mail function in the receiver side, and shows the functional means from receiving electronic mail to notifying the user of receiving the electronic mail.

As a mail receiving means 26 receives electronic mail, a divided mail processing means 27 judges whether or not the received electronic mail data is divided mail. Therein, if it is judged that the received electronic mail data is divided mail, each of the received electronic mail pieces is stored in a divided mail storing unit 28. This process is repeated until all the divided sent mail pieces are received. When it is judged that all the divided sent mail pieces have been received, each of the received items of the divided received mail data is stored in a received mail storing unit 29, and the notification of mail receive to the user is displayed on the display unit 4.

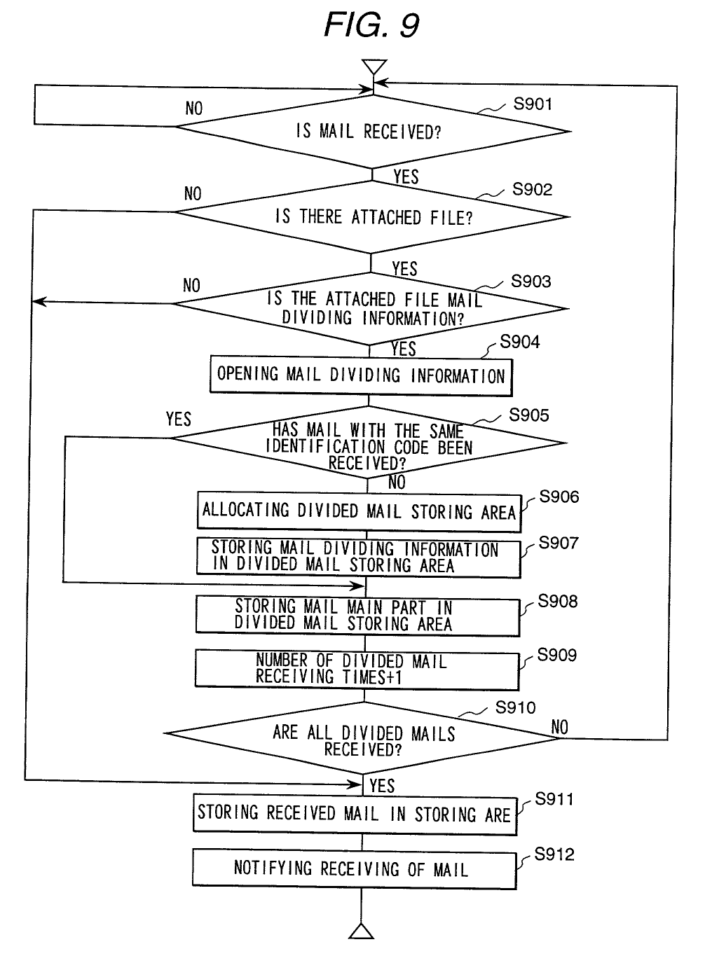

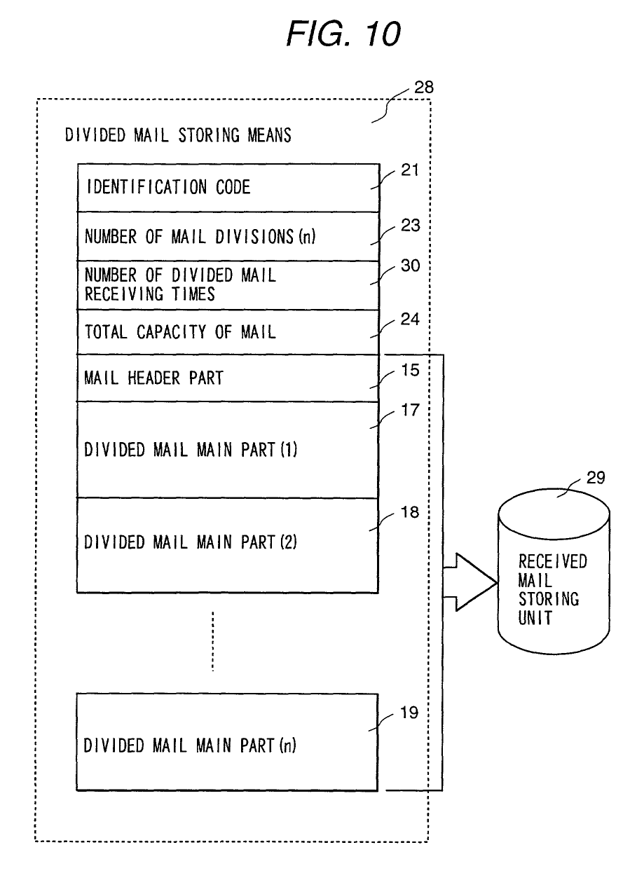

The divided mail processing means 27 will be described below, referring to FIG. 9 and FIG. 10. FIG. 9 is a flowchart showing the flow of processing executed by a preferable electronic mail processing program in order to realize the divided mail processing means 27. FIG. 10 is a view showing the inner structure of the divided mail storing unit.

Processing Step S901:

It is judged whether or not electronic mail data is received.

Processing Step S902:

It is judged whether or not an attached file is added to the received electronic mail, and the processing is branched to the processing step S903 or the processing step S911 depending on the judging result of presence and absence of the attached file.

Processing Step S903:

It is judged referring to an extension added to a file name of the attached file whether or not the attached file is a mail dividing information file 20, and the processing is branched to the processing step S911 or the processing step S904 depending on a form of the attached file.

The processing steps S902 and S903 are mail dividing information judging processing for judging whether or not the mail dividing information is added in the received mail data, and composes a mail dividing judging means.

Processing Step S904:

The mail dividing information file 20 is opened, and the identification code 21 is read.

Processing Step S905:

It is searched that there exists the identification code 21 of the read file in the divided mail storing unit 28, and it is judged whether or not receiving of the divided mail data is completed, and the processing is branched to processing step S906 or processing step S908 depending on the judged result.

Processing Step S906:

If the files having the specified identification code 21 are still not completed to be received, a mail storing area for a total capacity of mail 24 of this identification code 21 is secured in the divided mail storing unit 28.

Processing Step S907:

As shown in FIG. 10, the identification code 21, the number of mail divisions 23 and the total capacity of mail 24 are stored in the divided mail storing unit 28. The numeral “0” is set to the number of divided mail receiving times 30.

Processing Step S908:

The mail main part of the divided received mail, which has been received, is stored in the position shown by the sub-number 22.

Processing Step S909:

The number of divided mail receiving times 30 is incremented by 1.

Processing Step S910:

By comparing the number of mail divisions 23 with the number of divided mail receiving times 30, it is judged whether or not all the divided sent mail divisions are received, and the processing is branched to the processing step S901 or the processing step S911 depending on the judged result.

The processing step S910 is divided mail receiving judging processing, and composes the divided mail receiving judging means.

Processing Step S911:

The data below the mail header part 15 in the divided mail storing unit 28 is transferred to the received mail storing unit 29.

The processing steps S907 to S909 and S911 are mail reconstituting processing for reconstituting the plurality of divided received mail data items, which are received, to the original single form of mail data, and compose a mail reconstituting means.

Processing Step S912:

Receiving of mail is notified using the display unit 4.

Since the present invention is constructed as described above, it is possible to realize an information processor having an electronic mail function which can easily send and receive electronic mail attached with a large-sized file, and to realize a recording medium for recording an electronic mail processing program for the information processor.

What is claimed is:

1. An information processor having an electronic mail function, which comprises:
a mail size upper limit value storing means for storing at least one upper limit value of a sending destination mail size;
a mail size comparing means for comparing said upper limit value stored in said mail size upper limit value storing means with a size of a mail main part of sent mail;
a sent mail dividing means for dividing said sent mail into a plurality of sub-mail sections when the size of said sent mail exceeds said mail size upper limit value; and
a mail sending means for sequentially sending sets of information individually including said sub-mail sections.

2. An information processor having an electronic mail function according to claim 1, which further comprises a destination-based information registration database, data being registered in said destination-based information registration database, said data being destination-based information including whether or not a mail address, a mail upper limit value and a divided mail reconstituting program for reconstituting said plurality of sub-mail sections to the original mail exist in each destination.

3. An information processor having an electronic mail function according to claim 2, which further comprises means for setting data to said destination-based information registration database, said data being information on judging whether or not there is necessity of attaching said reconstituting program.

4. An information processor having an electronic mail function according to claim 1, which further comprises a mail dividing information adding means for adding mail dividing information necessary for reconstituting said plurality of divided sub-mail sections to the original mail form to each of said sets of information.

5. An information processor having an electronic mail function according to claim 4, wherein said mail dividing information attached to each of the sub-mail sections includes an identification code for identifying the original mail, sub-numbers for expressing order of said sub-mail sections, a dividing number of the mail, and a capacity of each of said sub-mail sections.

6. An information processor having an electronic mail function according to claim 2, wherein said reconstituting program is a program for reconstituting said original mail based on all said received sub-mail sections and said mail dividing information attached to each of said sub-mail sections.

7. An information processor having an electronic mail function according to claim 2, which further comprises
means for automatically attaching said dividing mail reconstituting program to sent mail when it is judged that a destination does not have said divided mail reconstituting program.

8. An information processor having an electronic mail function according to claim 1, wherein said mail size upper limit value storing means comprises a mail size upper limit value storing part; and a mail size upper limit value input means for inputting a mail size upper limit value for each destination, said mail size upper limit value being stored in said mail size upper limit value storing part.

9. An information processor having an electronic mail function according to claim 8, wherein said mail size upper limit value storing means further comprises a mail size upper limit value switching means for switching a mail size upper limit value used by said mail size comparing means corresponding to a destination.

10. An information processor having an electronic mail function according to claim 1, which further comprises means for setting a subject name for each of the sub-mail sections, said subject name being a name of an original mail added with data corresponding to number of divided sections and dividing order of said sub-mail sections.

11. An information processor having an electronic mail function according to claim 1, wherein it is displayed on a display unit of said information processor that sent mail is divisionally being sent.

12. An information processor having an electronic mail function according to claim 1, wherein said dividing number is set so as to be minimized.

13. An information processor having an electronic mail function according to claim 1, wherein said dividing number is set so as to equalize capacities of the sub-mail sections.

14. An information processor having an electronic mail function, which comprises:
a mail dividing judging means for judging whether or not mail dividing information is added in received mail data;
a divided-mail receiving judging means for judging referring to the mail dividing information whether or not all of sending sub-mail sections can be received; and
a mail reconstituting means for reconstituting the sections of sending sub-mail data to a form of a single original item of sending mail data.

15. An information processor having an electronic mail function according to claim 14, wherein it is displayed on a display unit of said information processor that received mail is divisionally being sent.

16. A method of sending and receiving electronic mail, the method comprising the steps of:
accepting a request of sending mail;
acquiring a mail size upper limit value of a destination based on an address of said destination;
comparing a size of the mail to be sent with said mail size upper limit value of the destination;
dividing the mail to be sent into sub-mail sections according to an appropriate dividing method and sending the sub-mail sections by attaching dividing information to each of the sub-mail sections, when the size of the mail to be sent is larger than said mail size upper limit value of the destination;
attaching a reconstituting program of divided mail to the sent mail when the reconstituting program is not provided to the destination; and
directly sending the mail to be sent when the size of the mail to be sent is smaller than said mail size upper limit value of the destination.

17. A method of sending and receiving electronic mail according to claim 16, wherein when the mail to be sent is divisionally sent, it is displayed on a display unit that the mail is divisionally sent.

18. A method of sending and receiving electronic mail, the method comprising the steps of:
judging whether or not received mail is divisionally being sent;
after receiving all sub-mail sections, reconstituting the received sub-mail sections to a mail before divided using a reconstituting program and dividing information attached to each of the mail sections when the received mail is divisionally sent; and
executing normal receiving processing when the received mail is not divisionally sent.

19. A method of sending and receiving electronic mail according to claim 18, wherein when the received mail is divisionally sent, it is displayed on a display unit that the mail is divisionally sent.

20. A recording medium storing an electronic mail processing program for realizing an electronic mail function by loading the electronic mail processing program into an information processor, wherein said electronic mail processing program includes a program executing:
processing for comparing an upper limit value of sent mail size with a size of mail to be sent; and
processing for sending the mail by automatically dividing mail data to be sent into a plurality of sub-mail sections when the size of the mail to be sent exceeds the upper limit value of sent mail size.

21. A recording medium storing an electronic mail processing program according to claim 20, which further includes a program for executing mail dividing information adding processing for adding information into sent mail data, said information being necessary for reconstituting divided items of divisional sub-mail data to a single original item of mail data.

22. A recording medium storing an electronic mail processing program according to claim 21, which further includes a program executing:
processing for attaching a reconstituting program for reconstituting divided items of divisional sub-mail data to a single original item of mail data; and
processing for setting to a destination database whether or not attaching of said reconstituting program is necessary.

23. A recording medium storing an electronic mail processing program according to claim 20, which further includes a program executing:
mail size upper limit value setting processing for setting an upper limit value of sent mail size; and
mail size upper limit value storing processing for storing the upper limit value of sent mail size set in the mail size upper limit value setting processing in a destination database an information processor.

24. A recording medium storing an electronic mail processing program according to claim 23, which further includes a program executing processing for switching the upper limit value of mail size referring to said destination database corresponding to a destination.

25. A recording medium storing an electronic mail processing program according to claim 20, which further includes a program executing processing for automatically changing a subject name of each of items of sub-mail data to each subject name corresponding to number of divided sections and dividing order of each of the items of sub-mail data.

26. A recording medium storing an electronic mail processing program for realizing an electronic mail function by loading the electronic mail processing program into an information processor, wherein said electronic mail processing program includes a program executing:
mail dividing information judging processing for judging whether or not mail dividing information is attached to received mail data;
divided mail receiving judging processing for judging based on the mail dividing information whether or not all necessary items of divisional sent sub-mail data have been received; and
mail reconstituting processing for reconstituting the received plurality of items of divisonal sent sub-mail data to a single original item of sending mail data.
